(19) United States
(12) Patent Application Publication
(10) Pub. No.: US 2016/0173935 A1
(43) Pub. Date: Jun. 16, 2016

(54) AUTOMATIC CHANNEL SELECTION FOR A PLACE-SHIFTING DEVICE

(71) Applicant: SLING MEDIA PVT LTD, Bangalore (IN)

(72) Inventors: Yatish J. Naik Raikar, Bangalore (IN); Mohammed Rasool, Bangalore (IN); Laxminarayana Dalimba, Bangalore (IN)

(21) Appl. No.: 14/568,766

(22) Filed: Dec. 12, 2014

(51) Int. Cl. H04N 21/438; H04N 21/442; H04N 21/466

(52) U.S. Cl. CPC H04N 21/4383; H04N 21/4667; H04N 21/44222

(57) ABSTRACT

A place-shifting device and a method for controlling a place-shifting device are provided. The place-shifting device, for example, may include, but not limited to, a processor configured to select at least two of a plurality of channels as selected channels to transmit to a single client device, a multi-session transcoder communicatively coupled to the processor, the multisession transcoder configured to substantially simultaneously transcode the selected channels from a first encoding scheme to a second encoding scheme, and a network interface communicatively coupled to the multi-session transcoder, the network interface configured to substantially simultaneously transmit the selected channels transcoded into the second encoding scheme to the single client device.

### TECHNICAL FIELD

The following relates to consumer electronics, and more particularly to place-shifting devices.

### BACKGROUND

Place-shifting devices allow users to view their media anywhere they have a network connection. Typical place-shifting devices have long start-up times. For example, many place-shifting devices require a user to connect to the place-shifting via a user device, wait for the place-shifting device to transmit a guide, utilize the guide to select a channel, then wait for the place-shifting device to begin transcoding a channel and transmitting the channel before the user can view any of their media. In some instances, the start-up time often exceeds fifteen seconds even when the user knows which program they want to watch. Furthermore, some place-shifting devices require a similar procedure, with a similar delay, every time the user wants to change a channel.

### SUMMARY

In accordance with one embodiment, a place-shifting device is provided. The place-shifting device may include, but not limited to, a processor configured to select at least two of a plurality of channels as selected channels to transmit to a single client device, a multi-session transcoder communicatively coupled to the processor, the multisession transcoder configured to substantially simultaneously transcode the selected channels from a first encoding scheme to a second encoding scheme, and a network interface communicatively coupled to the multi-session transcoder, the network interface configured to substantially simultaneously transmit the selected channels transcoded into the second encoding scheme to the single client device.

In accordance with another embodiment, a method of controlling a place-shifting device is provided. The method may include, but is not limited to, selecting, by a processor, at least two of a plurality of channels as selected channels to transmit to a single client device, transcoding, by a multi-session transcoder communicatively coupled to the processor, the selected channels substantially simultaneously, and transmitting, by a network interface communicatively coupled to the multi-session transcoder, the transcoded selected channels substantially simultaneously to the single client device.

### DESCRIPTION OF THE DRAWING FIGURES

Exemplary embodiments will hereinafter be described in conjunction with the following drawing figures, wherein like numerals denote like elements.

FIG. 1 is a block diagram of a place-shifting device, in accordance with an embodiment;

FIG. 2 is a block diagram of another exemplary place-shifting device, in accordance with an embodiment;

FIG. 3 is a flow chart illustrating an exemplary method for operating a place-shifting device in accordance with an embodiment; and

FIG. 4 illustrates an exemplary client device in accordance with an embodiment.

### DETAILED DESCRIPTION

According to various exemplary embodiments, a place-shifting device and a method for controlling a place-shifting device are provided. The place-shifting device utilizes a multi-session transcoder, allowing the place-shifting device to transmit multiple channels to a user at the same time. As discussed in further detail below, the place-shifting device attempts to anticipate the channels to the user that the user is most likely to want to view based upon multiple selection factors. The selected channels may be transmitted to a user device as soon as the user device is connected with the place-shifting device, reducing the time between when the user connects to the place-shifting device and when the user can begin watching a program. Furthermore, because multiple channels are transmitted at the same time, the amount of time needed to switch between channels can be reduced.

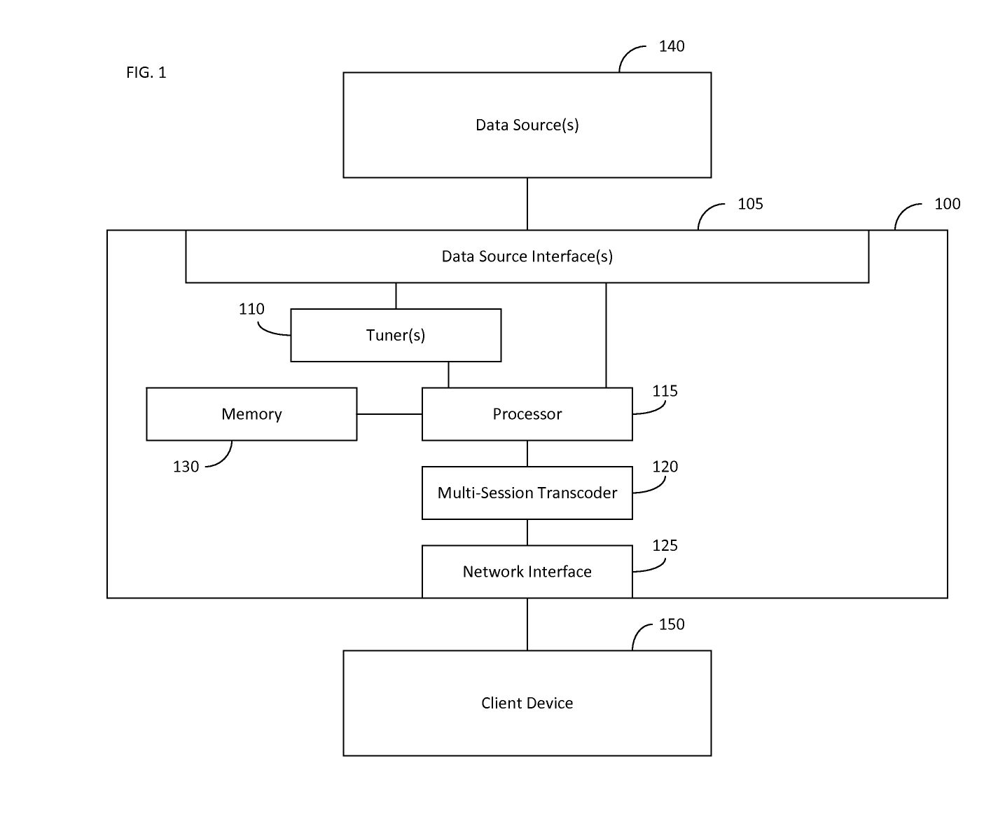

FIG. 1 is a block diagram of a place-shifting device 100, in accordance with an embodiment. In general, the place-shifting device 100 receives media at one location, such as a user's home or business, and transmits the received media to a user over a secure network connection. Accordingly, the place-shifting device 100 device allows a user to view their media anywhere the user has a network connection.

The place-shifting device 100 illustrated in FIG. 1 includes at least one data source interface 105. The data source interface(s) 105 can include, for example, one or more coaxial style interfaces, HDMI style interfaces, RJ45 network style interfaces, wireless data interfaces, or the like. The data source interface(s) 105 receive data from one or more data sources 140. The data source(s) 140 may include, but are not limited to, satellite television, cable television, an antenna based television system, a local media source (e.g., a Blu-ray player, a DVD player, a video game console, A digital video recorder, etc.), a remote media source (e.g., network delivered media content), or the like.

In embodiments where the data source 140 transmits encoded data, such as a satellite or cable television source, the place-shifting device 100 includes one or more tuners 110. The tuner(s) 110 filters the signal received from the data source 140 for a selected channel, demodulate the channel, and convert the signal into video and audio signals. The place-shifting device 100 may have multiple tuners such that multiple channels can be can be received simultaneously, as discussed in further detail below.

Each tuner 110 is coupled to a processor 115. The processor 115 may be a central processing unit (CPU), a graphics processing unit (GPU), an application specific integrated circuit (ASIC), a field programmable gate array (FPGA), a microcontroller, or any other logic circuit or combination thereof. As discussed in further detail below, the processor 115 controls the operation of the place-shifting device 100. If one or more of the data sources 140 does not require a tuner 110, data from the data source 140 may be transmitted directly to the processor 115.

The place-shifting device 100 further includes a multi-session transcoder 120. The multi-session transcoder 120 encodes the media received by the processor 115. The multi-session transcoder 120 may be, for example, be a central processing unit (CPU), a graphics processing unit (GPU), an application specific integrated circuit (ASIC), a field programmable gate array, a microcontroller, or any other logic circuit or combination thereof. The multi-session transcoder 120, for example, may use one or more audio/video codecs including, but not limited to, MPEG, H264, WMV, AAC or the like, to encode the media. As the name suggests, the multi-session transcoder 120 is capable of transcoding multiple media channels simultaneously. For example, if the place-shifting device 100 includes four tuners 110 for simultaneously decoding four channels from a television service, the multi-session transcoder 120 may be configured to transcode the four channels simultaneously for output, as discussed in further detail below. While FIG. 1 illustrates that the processor 115 and the multi-session transcoder 120 are separate elements, one of ordinary skill in the art would recognize that the processor 115 and the multi-session transcoder 120 may be the same unit.

The multi-session transcoder 120 is coupled to one or more network interfaces 125. The network interface(s) 125 may include any wired or wireless communication protocol, including, but not limited to, WIFI, cellular, Ethernet, MoCA, or the like. The place-shifting device 100 is configured to output the media transcoded by the multi-session transcoder 120 to one or more client devices 150. The client device(s) 140 may include, but are not limited to, cellular phones, tablets, laptop computers, desktop computers, or any other device capable of receiving and displaying media.

The place-shifting device 100 further includes memory 130. The memory 130 may be any combination of non-volatile memory and volatile memory. While the memory 130 is illustrated as being a component within the place-shifting device 100, the memory 130 could also be located remotely, such as a cloud based memory system. In embodiments with a remote memory 130, the processor 115 may be communicatively coupled to the memory via the network interface 125. As discussed in further detail below, the memory 130 may store user profile data used to determine which channels to present to a user. The memory 130 may also store non-transitory computer readable instructions for operating the place-shifting device, as discussed in further detail below.

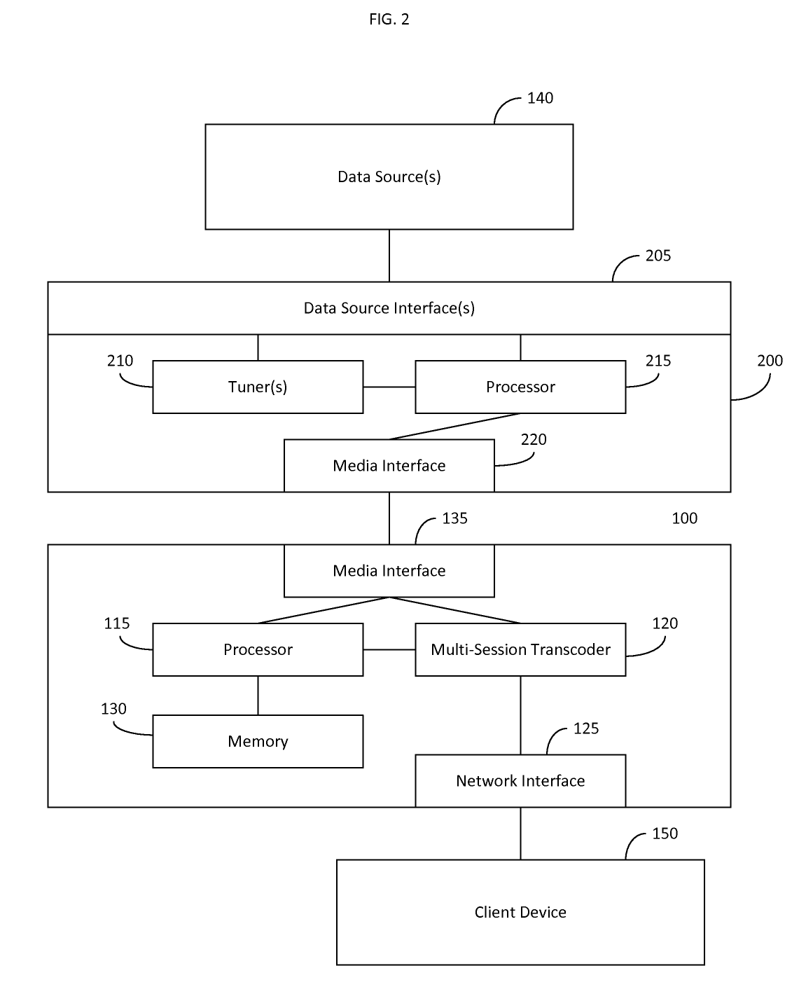

FIG. 2 is a block diagram of another exemplary place-shifting device 100, in accordance with an embodiment. In the embodiment illustrated in FIG. 2, the place-shifting device 100 is separate from a data source receiver 200. The data source receiver 200 may be, for example, a digital video recorder (DVR), a set-top box or other television receiver, a television, a computer (e.g., a desktop computer, a laptop computer, a tablet, a cellular phone, etc.), a DVD players, a Blu-ray player, a video game console, a dedicated internet media receiver, or the like, or a combination thereof. The data source receiver 200 includes one or more data source interfaces 205, one or more tuners 210 and one or more processor 215 similar to the data source interface(s) 105, tuner(s) 110 and a processor(s) 115 discussed above. The data source receiver 200 further includes a media interface 220. The media interface may be 220, for example, a HDMI style interface, an RCA interface, a coaxial interface, a wired-network interface, a wireless network interface, or any other interface capable of transmitting and audio/video signal, or any combination thereof. The media interface 220 outputs audio/video to a corresponding media interface 135 of the place shifting device 100 illustrated in FIG. 2. The media interface 135 is coupled to the processor 115 and/or the multi-session transcoder 120 and provides the media to be streamed to the place-shifting device 100.

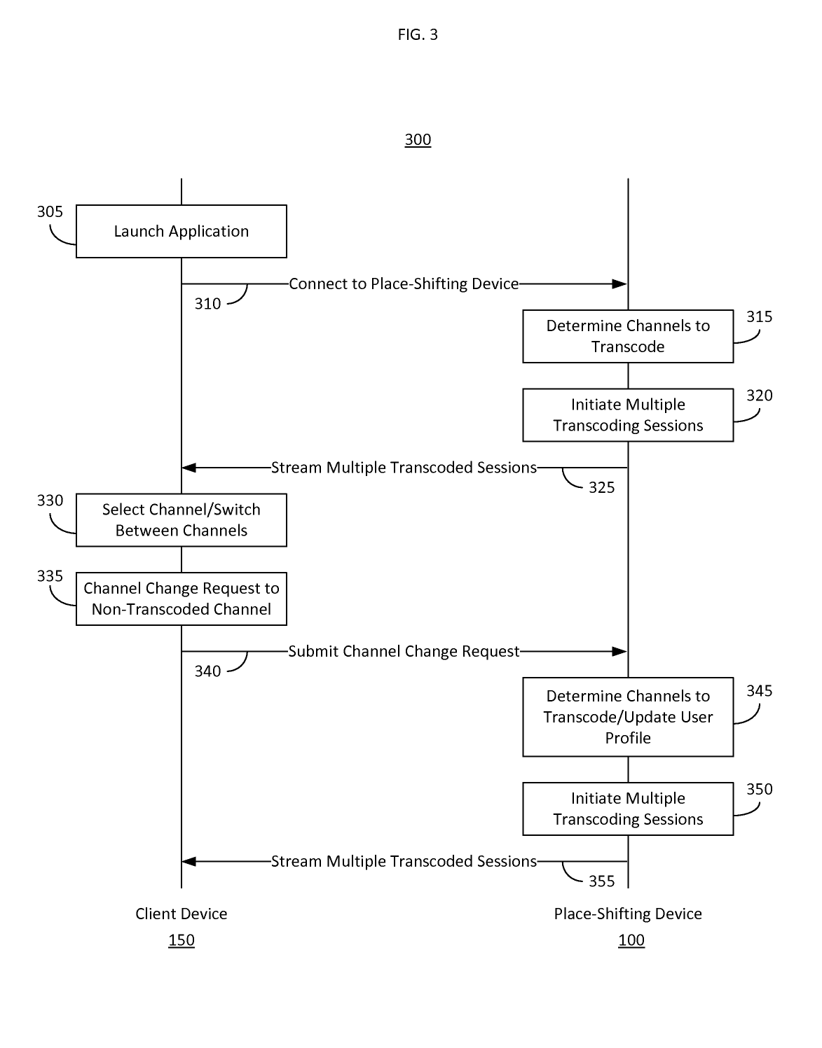

FIG. 3 is a flow chart illustrating an exemplary method 300 for operating a place-shifting device 100 in accordance with an embodiment. The method 300 begins when a user of a client device 150 launches a place-shifting application on the client device 150. (Step 305). The client device 150 then transmits a request to the place-shifting device 100 to connect to the place-shifting device 100. (Step 310). In one embodiment, for example the request can include an indication of the user of the device so that the processor 115 of the place-shifting device 100 can access a corresponding user-profile stored in the memory 130. In another embodiment, for example, the connection request can include the entire user profile. When the user launches place shifting application on client device 150, a background control/streaming connection is established with place shifting device 100. The User/Device profile and current bandwidth information is used by the place shifting 100 device to decide which channels are to be streamed.

The processor 115 of the place-shifting device 100 then determines which channels to transcode before a user even selects a channel to view. (Step 315). Because the processor 115 selects channels to view even before the user selects a channel, the start-up time (i.e., the time between when the user connects to the place-shifting device 100 and the time when a user can begin watching content) is minimized. The processor 115 may determine which channels to transcode based upon multiple selection factors. One selection factor may be a number of transcoding sessions which are available. In other words, the processor may select how many channels to transcode based upon a number of simultaneous transcoding sessions the multi-session transcoded 120 is capable of processing. In one embodiment, for example, the multi-session transcoder 120 of the place-shifting device 100 may have four possible transcoding channels. However, the number of possible transcoding channels may vary depending upon the capabilities of the multi-session transcoder 120. In one embodiment, for example, one or more available transcoding sessions may be in use by other users connected to the place-shifting device, thereby reducing the number of transcoding sessions which are available.

Furthermore, the processor 115 may select the number of transcoding sessions based upon the type of data connection being used by the client device 150. If a client device 150 is using cellular data, for example, the processor may reduce the number of transcoded channels to reduce the amount of data consumed. In another embodiment, for example, a number of transcoding sessions may be reduced over time. If the processor initially chooses to transcode four channels, for example, the processor may reduce the number of transcoded channels to three, two or even one channel to reduce bandwidth consumption. The reduced number of channels may be based upon one or more of, the type of the data connection and user usage patterns. For example, if the user generally switches between two channels, the processor 115 may initially transcode four channels, then reduce the number of channels after the user has begun switching between two of the channels. Furthermore, the processor may also select a resolution and a bit-rate for each of the selected channels based upon available bandwidth. In one embodiment, for example, the resolution and bit-rate may be selected to be identical for each of the selected channels. In other embodiments, for example, the resolution and bit-rate of the selected channels may vary. For example, the channel the viewer selects to watch may be transmitted at a higher resolution and bit-rate, while the background channels being transmitted by the place-shifting device 100 at a lower resolution and bit-rate.

The processor 115 may also determine which channels to transcode based upon a user profile stored in the memory 130. The user profile may store, for example, the channel the user previously watched and viewing patterns of the user, current trending channels on social network, custom algorithms, data for personalized discovery services, or the like. The viewing patterns can include, for example, one or more favorite channels of a user. For example, if a user watches one channel, for example, fifty percent and no other channel more than, for example, ten percent of the time the user is logged into the place-shifting device, the processor 115 may only select the most watched channel to transcode. If, for example, a user watches two, three or more channels nearly exclusively, the processor 115 could select all (or as many as the multi-session transcoder 120 is capable of transcoding) of the users most watched channels to transcode. The channels determined to be favorites may be channels which the user watches above a predetermined percentage of the time. The predetermined percentage may be, for example, twenty-five percent; however, one of ordinary skill in the art would recognize that the predetermined percentage can vary. A user could also set one or more channels as favorites such that the channels are always transmitted to the client device 150.

In one embodiment, for example, the user profile may store login/password data for one or more social networks that the user is a member of. The processor 115, for example, may then monitor the user's social network to determine channels and programs that are trending on the user's social network.

The stored viewing pattern of the user could also include data based upon what a user typically watches by date and time. In other words, if the user usually watches a news program on a particular channel on Wednesday mornings, the processor 115 may select that particular channel to include in the transcoding sessions if the user connects to place-shifting device around that date and time.

The processor 115 may also determine which channels to transcode based numbers of viewers for a currently broadcasting program, programs currently trending on social media, or the like. The processor 115, via the network interface 125, may communicate with a data source 140 the channels are being received from or with a separate data server (not illustrated) to determine which channels are most popular in real time or trending in real time.

The channels determined to transcode may be based upon the number of channels available and a ranking of the other selection factors. A default ranking for a 4-session multi-session transcoder 120 may be, for example: 1) the previously watched channel(s) such the last watched channel and/or one or more favorite channels; 2) channel(s) typically watched by the user at the particular date and time; 3) the hottest current channel (i.e., a channel currently being watched by the most users; and 4) the channel trending the most on one or more social networks. However, one of ordinary skill in the art would recognize that the default rankings may vary. Furthermore, a user of the place-shifting device 100 may be able to alter the default rankings such that the programs the user is most likely to watch are included in the channel determination of Step 315. In one embodiment, for example, the processor 115 may override the default rankings or user rankings for a channel which would not ordinarily be seen, for example, if the user has multiple favorite channels. If, for example, a channel is particularly hot or trending, for example, major breaking news, major sporting events, unique programs (awards shows, live performances, or the like), the processor 115 may include the channel in the multi-session stream.

In another embodiment, for example, the processor 115 may choose to transcode a single channel at multiple different bitrates and/or resolutions. This embodiment would enable seamless transition to different resolution without buffering wheels providing better user experience. In other words, if the available bandwidth for the client device 150 changes (either increasing or decreasing), rather than having to start a new transcoding session using the optimal bitrate/resolution for the currently available bandwidth, the processor 115 can be already transcoding the channel at the optimal bitrate/resolution for the currently available bandwidth, reducing the time required to switch to the different bitrate/resolution. This embodiment could also be used when a user wishes to switch the client device 150 the user is watching the channel on. If, for example, a first client device is a cellphone or tablet and a second client device is a television, already having the single channel being transcoded at multiple bitrates reduces the downtime when the user wants to switch the stream from the first client device to the second, especially when the different client devices are operating on different networks having different available bandwidth or there are different optimal bitrates/resolutions for the different client devices.

After the processor 115 determines which channels to transcode, the multi-session transcoder 120 is instructed to begin simultaneously, or substantially simultaneously, transcoding each of the selected channels (Step 320). The transcoding may be done, for example, via a multisession transcoder chip, multiple multisession or single-session transcoding chips, or via one or more powerful central processing units and implement the multi-transcoding software by using time division multiplexing.

The processor 115 then utilizes the network interface 125 to simultaneously, or substantially simultaneously, transmit all of the transcoded channels to the client device 150. (Step 325). In other words, all of the channels being transcoded by the multi-session transcoder 120 are transmitted to the client device 150 in such a manner that all of the channels can be viewed on the client device.

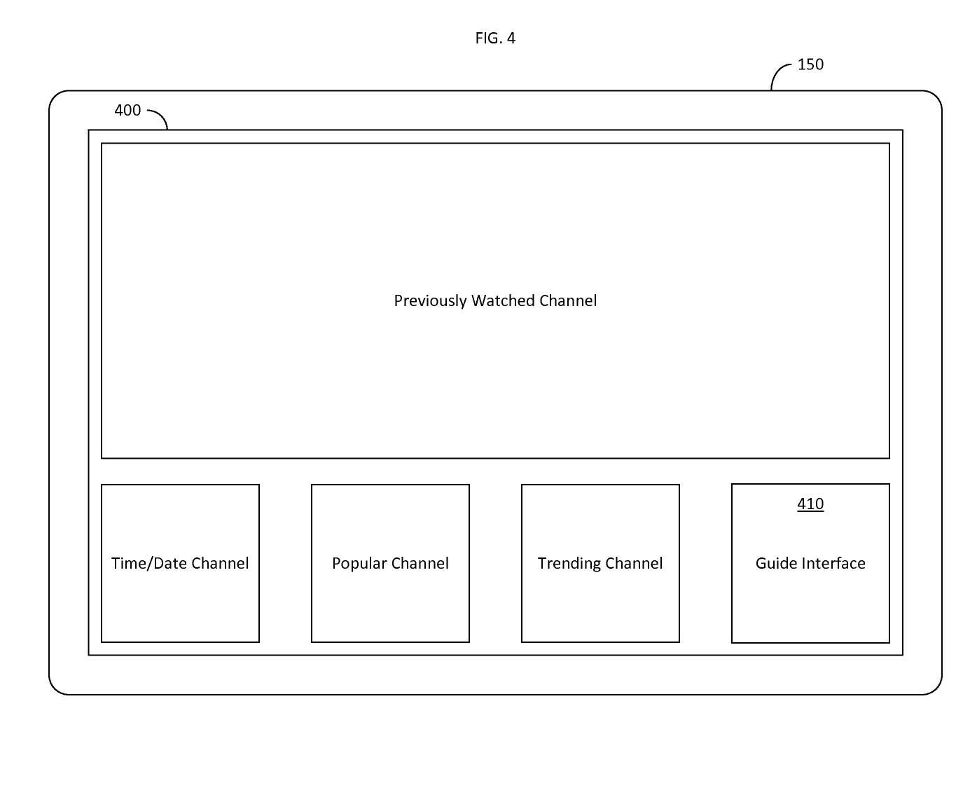

FIG. 4 illustrates an exemplary client device 150 in accordance with an embodiment. The client device includes a screen 400. The screen may be an LCD display, an OLED display, or any other display type capable of displaying media. In particular, FIG. 4 illustrates an exemplary display 400 after the processor 115 instructs the multi-session transcoder 120 to begin streaming the selected channels to the client device 150. As seen in FIG. 4, all of the streaming channels are displayed on the screen 400 simultaneously, allowing the user to see what program is being streamed on each channel. While FIG. 4 illustrates that the display 400 of the client device 150 displays a large “previously watched channel” and three smaller channels (Time/Date Channel, a Popular Channel, and a Trending Channel), one of ordinary skill in the art would recognize that the size, orientation and configuration of each of the displayed channels can vary. The display further includes a guide interface 410. The guide interface allows a user to select a non-displayed channel, as discussed in further detail below.

In one embodiment, for example, the display 400 may be a touch screen display capable of receiving user input. The user input may be, for example, commands to select one of the displayed channels to commands to select a different channel from the guide interface 410. While not illustrated in FIG. 4, one of ordinary skill in the art would recognize that the client device could receive user input from a variety of different input devices, including, but not limited to, the display 400, a mouse, a keyboard, voice commands, a scroll wheel, or the like, or any combination thereof. In one embodiment, for example, the channels may be displayed as live tiles. A description of the program on the channel may also be displayed with the live tile. In other embodiments, for example, merely a description of the immediately available channels and/or programs being played on the channels may be displayed.

Returning to FIG. 3, a user of the client device 150 then has the option to select one of the transcoded channels (Step 330) or to select another channel via the guide interface 410 using one or more of the user input devices. (Step 335). If a user selects one of the channels which is already be transmitted to the client device 150, the client device 150 can begin displaying the channel immediately (if not already being displayed on a live tile) as the data for the channel is already being transmitted to the client device 150. In one embodiment, for example, a selected channel may be displayed full screen on the display 400 of the client device 150. In another embodiment, for example, the selected channel will be moved to the largest display tile, while non-selected channels displayed in the smaller display tiles or can be further reduced in size.

Accordingly, because the multi-session transcoder 120 transmits multiple channels to the client device 150 as soon as the client device 150 connects to the place-shifting device 100, a user can begin watching any of the received channels without any further processing requests to the place-shifting device 100. Furthermore, because the place-shifting device 100 transmits multiple channels to the client device 150, a user of the client device 150 can switch between any of the received channels without any delay. In contrast, current place-shifting devices require a command to be sent back to the place-shifting device every time the user selects an initial channel to watch or changes a channel. By utilizing the multi-session transcoder 120 to transmit multiple channels, including the most likely channels that the user will want to watch, the time between when a user launches the place-shifting application and the time the user can start watching a desired channel can be reduced. In one embodiment, for example, all of the transcoded channels may be transmitted to the client device 150 during the user's session. However, in another embodiment, the place-shifting device may stop transmitting non-selected channels to the client device 150 in order to reduce bandwidth consumption. In this embodiment, the multi-session transcoder 120 may continue to transcode the non-selected channels such that when the user tries to switch to one of the other channels the place-shifting device 100 can immediately start transmitting the new channel data. This embodiment avoids the need for a complete reset of place-shifting device 100 on a channel change which reduces the time needed to begin transmitting the newly selected channel.

If a user desires a different channel, one which is not already being transmitted by the place-shifting device 100, the client device transmits the channel change request to the place-shifting device. (Step 340). The processor 115, upon receiving the channel change request, then selects updated channels to transcode. (Step 345). The updated selected channels would include the channel selected by the user as well as one or more other channels based upon the number of transcoding sessions available as well as the other selection factors discussed above. In one embodiment, for example, the processor 115 may also update the user profile stored in the memory 130 to include the channel selection. Accordingly, as the user profile is updated, the processor 115 is more likely to select one of the channels that the user is likely to want to watch.

As discussed above, after the processor 115 selects the channels to be transcoded, the multi-session transcoder 120 begins transcoding all of the new channels (Step 350), though some may be the same channels as before, and utilizes the network interface 125 to transmit all of the transcoded channels to the client device in the same manner as discussed above. (Step 355). Because multiple channels are still transmitted to the client device 150, a user of the client device 150 will still be able to switch between any of the streamed channels without delay.

While the above description discusses transmitting channels, one of ordinary skill in the art would recognize that the selected channels could be a channel from a broadcast source, a program saved in the memory 130, an alternative media source (a streaming media source, a Blu-ray player, etc.), or programs originating from any of the other data sources 140 discussed above.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A place-shifting device, comprising:
a processor configured to select at least two of a plurality of channels as selected channels to transmit to a single client device before a user selects one of the plurality of channels;
a multi-session transcoder communicatively coupled to the processor, the multisession transcoder configured to substantially simultaneously transcode the selected channels from a first encoding scheme to a second encoding scheme; and
a network interface communicatively coupled to the multi-session transcoder, the network interface configured to substantially simultaneously transmit the selected channels transcoded into the second encoding scheme to the single client device.

2. The place shifting device of claim 1, wherein the processor is further configured select the selected channels based upon a number of simultaneous transcoding sessions the multi-session transcoder is capable of processing.

3. The place shifting device of claim 1, further comprising a memory,
wherein the processor is further configured to select the selected channels based upon a user profile stored in the memory.

4. The place shifting device of claim 3, wherein the user profile stores data on a previously watched channel.

5. The place shifting device of claim 3, wherein the user profile stores data on stored viewing pattern by date and time.

6. The place shifting device of claim 1, wherein the processor is further configured to select the selected channels based upon real time popularity of the received plurality of channels.

7. The place shifting device of claim 1, wherein the processor is further configured to select the selected channels based upon which of the received plurality of channels are trending on social media.

8. The place shifting device of claim 1, wherein at least four of the plurality of channels are substantially simultaneously transcoded by the multi-session transcoder and the network interface substantially simultaneously transmits the at least four of the plurality of channels to the single client device.

9. The place shifting device of claim 3, wherein the processor is further configured to:
receive, via the network interface, a channel change request to a channel other than the selected channels;
update the user profile stored in the memory based upon the channel change request;
select the channel other than the selected at least two of the plurality of channels and at least one other channel as updated selected channels to transmit to the single client device.

10. The place shifting device of claim 1, further comprising:
a data source interface configured to receive the plurality of channels from a data source; and
a plurality of tuners communicatively coupled to the processor, each of the plurality of tuners configured to demodulate one of the selected channels from the received plurality of channels.

11. A method of controlling a place-shifting device, comprising:
selecting, by a processor, at least two of a plurality of channels as selected channels to transmit to a single client device before a user selects one of the plurality of channels;
transcoding, by a multi-session transcoder communicatively coupled to the processor, the selected channels substantially simultaneously; and
transmitting, by a network interface communicatively coupled to the multi-session transcoder, the transcoded selected channels substantially simultaneously to the single client device.

12. The method of claim 11, wherein the selecting further comprises, selecting the selected channels based upon a number of simultaneous transcoding sessions the multi-session transcoder is capable of processing.

13. The method of claim 11, wherein the selecting further comprises selecting the selected channels based upon a user profile stored in a memory communicatively coupled to the processor.

14. The method of claim 13, wherein the user profile stores data on a previously watched channel.

15. The method of claim 13, wherein the user profile stores data on stored viewing pattern by date and time.

16. The method of claim 13, further comprising:
receiving, via the network interface, a channel change request to a channel other than the selected channels;
updating the user profile stored in the memory based upon the channel change request; and
selecting the channel other than the selected at least two of the plurality of channels and at least one other channel as updated selected channels to transmit to the single client device.

17. The method of claim 11, wherein the selecting further comprises selecting the selected channels based real time popularity of the plurality of channels.

18. The method of claim 11, wherein the selecting further comprises selecting the selected channels based upon which of the plurality of channels are trending on social media.

19. The method of claim 11, wherein the selecting further comprises selecting at least four of the plurality of channels as selected channels.

20. The method of claim 11, wherein the selected channels include at least one channel selected to be transcoded at at least two different bitrates or two different resolutions.
